(19) United States
(12) Patent Application Publication
(10) Pub. No.: US 2006/0022572 A1
(43) Pub. Date: Feb. 2, 2006

(54) Enhanced structure for-color fluorescent screens

(76) Inventor: Wen-Chieh Lu, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/902,170

(22) Filed: Jul. 30, 2004

(51) Int. Cl. H01J 1/62

(52) U.S. Cl. 313/462; 313/486

(57) ABSTRACT

A kind of enhanced structure for full-color fluorescent screens, which includes a kind of white-color or achromatic fluorescent powder sensible to ultraviolet rays which, when illuminating and absorbing, emits RGB lights in orange red, green and violet blue that interact and configure to form a full-color screen on a substrate, which is printed with orange red layer, green layer and violet blue layer in the size, pitch, overlapping, configuration and layout as that of the primary color. the RGB layers come in the size, pitch, overlapping, configuration and layout as that of the primary color and in the dark, color lights are emitted when illuminated by the ultraviolet ray to the fluorescent light layers and the color lights then, depending on the size, pitch and overlapping of the fluorescent powder dots, emit RGB lights in different intensities and the RGB color lights of different tones and intensities come to form a full-color figure of full color scale.

### BACKGROUND OF THE INVENTION

1. Field of the Invention

The present invention is a kind of enhanced structure for full-color fluorescent screens, in particular, a full-color screen forming multiple color scales when interacting with a fluorescent layer consisting of orange red, green and violet, the 3 elements of RGB, when the white or achromatic fluorescent powder is exposed and absorbed by ultraviolet ray and the round-shaped full-color-scale screen comes with orange red, green and violet fluorescent scales printed on the substrate in overlapping dots of original size and in layout and composition making the same emit color lights in the dark thanks to the illumination and absorption by the ultraviolet ray.

2. Description of the Related Art

The mixture of the three primary of light, referring to FIG. 1, orange red 1, green 2 and violet blue 3, also known as RGB, produces white light 4 and orange red 1 plus green 2 creates yellow light 5 and green 2 plus violet blue 3 creates light blue light 6 and eventually orange red 1 plus violet blue 3 produces pink light 7.

Although fluorescent light is in wide application in utility items, commercial signboards and other products, fluorescent colors we know today are only available in mono colors or 2 colors, not in full colors. In order to taking full advantage of RGB in full-color visualization, the inventor has been figuring out ways of converting RGB in full color and success was possible when this structure of forming full colors using RGB after repeated researches and laboratory works.

To have a full understanding of the structure, pattern, purpose and concept of this invention, please review the following figures and descriptions.

### SUMMARY OF THE INVENTION

The present invention has been accomplished to provide a kind of enhanced structure for full-color fluorescent screens, in particular, a full-color screen forming multiple color scales when interacting with a fluorescent layer consisting of orange red, green and violet, the 3 elements of RGB, when the white or achromatic fluorescent powder is exposed and absorbed by ultraviolet ray and the round-shaped full-color-scale screen comes with orange red, green and violet fluorescent scales printed on the substrate in overlapping dots of original size and in layout and composition making the same emit color lights in the dark thanks to the illumination and absorption by the ultraviolet ray.

### BRIEF DESCRIPTION OF THE DRAWINGS

FIG. 1 is a diagram of the changes of the overlapping RGB according to the prior art.

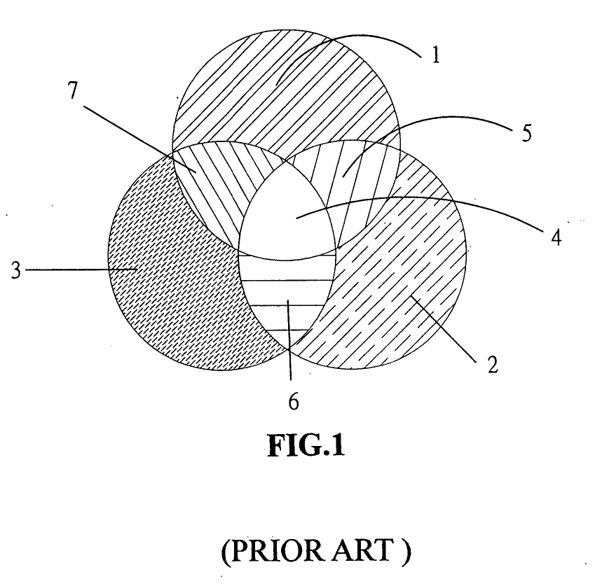

FIG. 2 is a diagram of the structure according to the present invention.

### DETAILED DESCRIPTION OF THE PREFERRED EMBODIMENTS

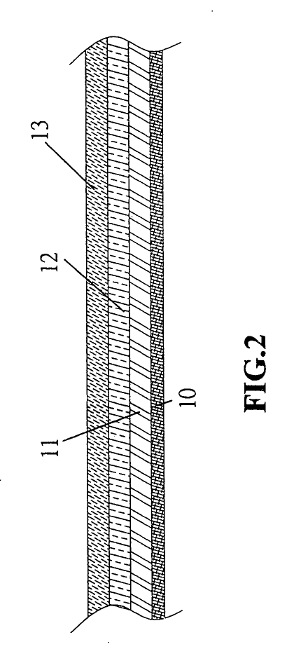

Referring to FIG. 2, the present invention of full-color fluorescent screens, in particular, a kind of white-color or achromatic fluorescent powder sensible to ultraviolet rays which, when illuminating and absorbing, emits RGB lights in orange red, green and violet blue that interact and configure to form a full-color screen on a substrate 10, which is printed with orange red layer 11, green layer 12 and violet blue layer 13 in the size, pitch, overlapping, configuration and layout as that of the primary color.

The substrate 10 can be of any material as it is provided mainly to house the fluorescent powder layers.

The RGB layers come in the size, pitch, overlapping, configuration and layout as that of the primary color and in the dark, color lights are emitted when illuminated by the ultraviolet ray to the fluorescent light layers and the color lights then, depending on the size, pitch and overlapping of the fluorescent powder dots, emit RGB lights in different intensities and the RGB color lights of different tones and intensities come to form a full-color figure of full color scale.

Accordingly, we learn that the structure of this invention does meet the expected effects and as it is not in announced application, the invention is apt for application for patent for its practicality and innovation. While submitting this application for patent, we would appreciate your favorable consideration and grant us with right of patent.

Further, the above is an embodiment of this invention and if the changes, functions and characteristics based on the concept remain within the scope of the manual and the figures, they shall be included in the scope of the invention.

What the invention claimed is:

1. A kind of enhanced structure for full-color fluorescent screens, in particular, a full-color screen forming multiple color scales when interacting with a fluorescent layer consisting of orange red, green and violet, the 3 elements of RGB, when the white or achromatic fluorescent powder is exposed and absorbed by ultraviolet ray and the round-shaped full-color-scale screen comes with orange red, green and violet fluorescent scales printed on the substrate in overlapping dots of original size and in layout and composition making the same emit color lights in the dark thanks to the illumination and absorption by the ultraviolet ray; in which the substrate can be of any material as it is provided mainly to house the fluorescent powder layers and the RGB layers come in the size, pitch, overlapping, configuration and layout as that of the primary color and in the dark, color lights are emitted when illuminated by the ultraviolet ray to the fluorescent light layers and the color lights then, depending on the size, pitch and overlapping of the fluorescent powder dots, emit RGB lights in different intensities and the RGB color lights of different tones and intensities come to form a full-color figure of full color scale.
